(19) United States
(12) Patent Application Publication
(10) Pub. No.: US 2010/0314869 A1
(43) Pub. Date: Dec. 16, 2010

(54) Pipe connector

(76) Inventor: Wen-Pin Kuo, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/456,198

(22) Filed: Jun. 11, 2009

(51) Int. Cl. F16L 37/091

(52) U.S. Cl. 285/321

(57) ABSTRACT

A pipe connector in accordance with the present invention comprises a hollow body, a rotator rotatably and co-axially sleeved on one end of the hollow body, a positioning device co-axially mounted between the hollow body and the rotator, and a holder co-axially mounted to rotator for holding the positioning device in place in the rotator. The positioning device includes a bind ring that is pre-expanded by an opener. The pipe is tightly bound to airtightly abut against the hollow body due to the restitution force of the bind ring when the pipe pushes the opener to make the opener detaching from the bind ring.

### BACKGROUND OF THE INVENTION

1. Field of the Invention

The present invention relates to a pipe connector, and more particularly to a pipe connector that is provided for nonmetal pipe, and can precisely and tightly clamp the nonmetal pipe.

2. Description of Related Art

A piping is an ordinary structure in many different technology fields, such as oil pipe, air pipe, water pipe, especially nonmetal pipes. The piping is necessary for transporting fluid. Under many conditions, the pipes need connectors to connect to a faucet, a valve or an elbow. According to the conventional technology, the pipe usually airtightly screwed onto the conventional pipe connector such that a tape seal is necessary to previously coiling the thread on the pipe. It is inconvenient. In addition, the pipe may wound around when being rotating such that the flow speed and quantity of the fluid in the pipe is decreased.

The present invention has arisen to mitigate and/or obviate the disadvantages of the conventional pipe connector.

### SUMMARY OF THE INVENTION

The main objective of the present invention is to provide an improved pipe connector that is provided for nonmetal pipe, and can precisely and tightly clamp the nonmetal pipe.

To achieve the objective, the pipe connector in accordance with the present invention comprises a hollow body having a pivot section and a connecting section sequentially formed on one end thereof, wherein the pivot section has diameter greater than that of the connecting section such that a first shoulder is formed between the pivot section and the connecting section. At least one O-ring is sleeved on the connecting section. A rotator is co-axially and rotatably mounted to the pivot section and has a second shoulder formed on an inner periphery thereof. A positioning device is co-axially mounted between the connecting section of the hollow body and the rotator. The positioning device includes a bind ring surrounding the connecting section and having a slot defined in the bind ring such that bind ring has a C-shaped cross-section. The bind ring has multiple protrusions longitudinally extending from a first end thereof and each protrusion abutting against the first shoulder. A ring of inner tapered plane is formed on a second end of the bind ring. An opener is mounted among the multiple protrusions, wherein the opener has an outer diameter greater than that of an inner diameter of the bind ring such that the bind ring is expanded and the slot is widened when the opener mounted onto the first end of the bind ring. The opener has a diameter smaller than a width of the first shoulder, and a relative distance between the first shoulder and the second shoulder. A check washer is mounted onto a distal end of the rotator opposite to the pivot section of the hollow body. The check has a ring structure and a series of engagements radially inwardly extending from the ring structure into the bind ring and abutting the tapered plane. A holder is securely mounted onto the rotator to prevent the positioning device from detaching from the rotator. A through hole is centrally defined in the holder to allow a pipe extending through the holder and into an annular gap between the connecting section and the bind ring.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a pipe connector in accordance with the present invention;

FIG. 2 is an exploded perspective view of a pipe connector in FIG. 1;

FIG. 3 is a cross-sectional view of the pipe connector of the present invention before being connected to a pipe; and

FIG. 4 is a cross-sectional view of the pipe connector of the present invention after being connected to a pipe.

### DETAILED DESCRIPTION OF THE INVENTION

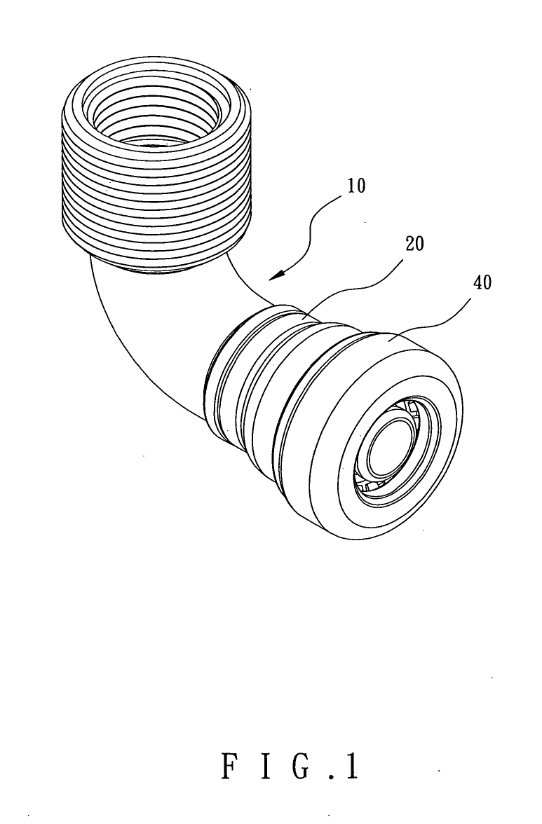

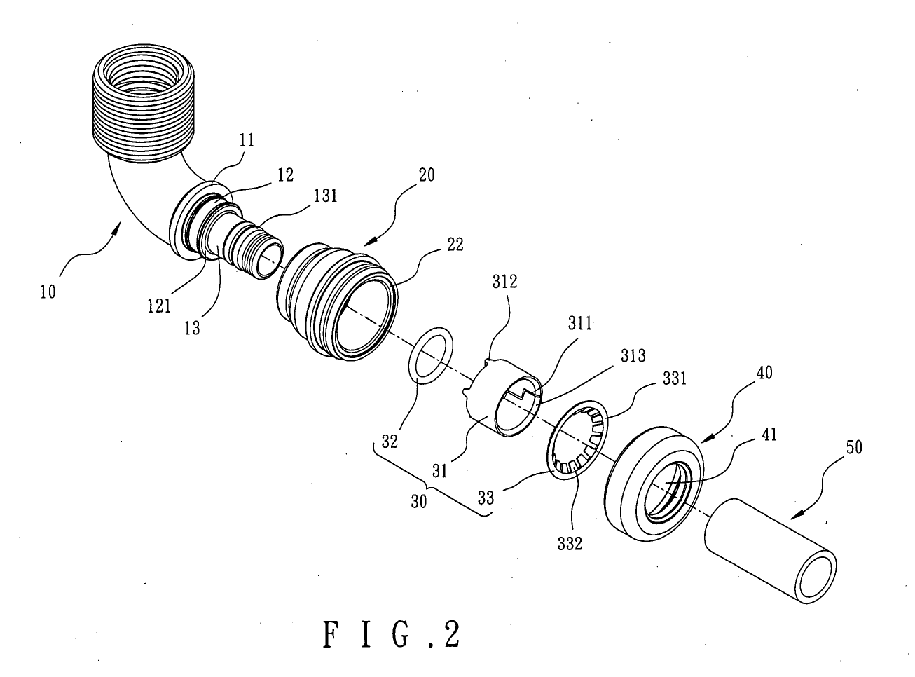

Referring to the drawings and initially to FIGS. 1-3, a pipe connector in accordance with the present invention comprises a hollow body (10), a rotator (20) rotatably and co-axially sleeved on one end of the hollow body (10), a positioning device (30) co-axially mounted between the hollow body (10) and the rotator (20), and a holder (40) co-axially mounted to rotator (20) for holding the positioning device (30) in place in the rotator (20).

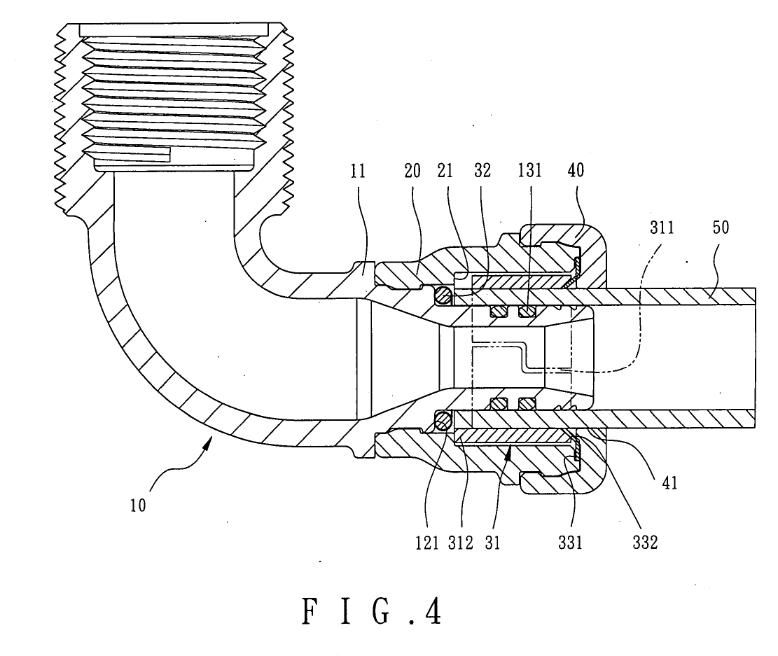

The hollow body (10) includes a flange (11) radially extending from an outer periphery of the hollow body (10). A pivot section (12) and a connecting section (13) sequentially formed on the outer periphery of the hollow body (10) relative to the flange (11), wherein the pivot section (12) has a diameter greater than that of the connecting section (13) such that a first shoulder (121) is formed between the pivot section (12) and the connecting section (13). At least one O-ring (131) is sleeved on the connecting section (13). In the preferred embodiment of the present invention, there are two O-ring (131) sleeved on the connecting section (13) for enhancing airtight effect between the connecting section (13) and the pipe (50), as shown in FIG. 4.

The rotator (20) is tubular rotatably mounted to the pivot section (12) of the hollow body (10). The rotator (20) has a second shoulder (21) formed on an inner periphery thereof. An annular groove (22) is defined in a distal end of the rotator (20) relative to the holder (40) and communicating with the inner periphery of the rotator (20).

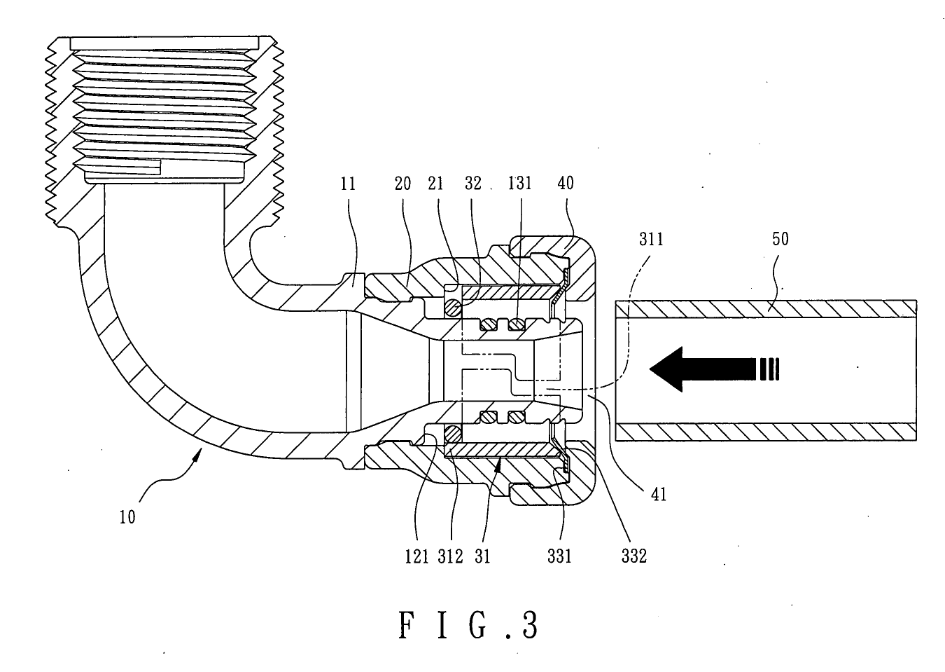

The positioning device (30) includes a bind ring (31) received in the rotator (20) and surrounding the connecting section (13) of the body (10). A slot (311) is defined in the bind ring (31) such that the bind ring (31) has a C-shaped cross-section. The bind ring (31) has multiple protrusions (312) longitudinally extending from a first end thereof and each protrusion (312) abuts against the first shoulder (121). A ring of inner tapered plane (312) is formed on a second end of the bind ring (31). An opener (32) is mounted among the multiple protrusions (312). The opener (32) has an outer diameter greater than an inner diameter of the bind ring (31) such that the bind ring (31) is expanded and the slot (311) is widened when the opener (32) mounted onto the first end of the bind ring (31), as shown in FIGS. 3 and 4. The opener (32) has a diameter smaller than a width of the first shoulder (121), and a relative distance between the first shoulder (121) and the second shoulder (21). A check washer (33) in mounted onto the distal end of the rotator (20). The check washer (33) has a ring structure (331) received in the annular groove (22) in the rotator (20), and a series of engagements (332) radially inwardly extending from the ring structure (331) into the bind ring (31) and abutting the tapered plane (313).

The holder (40) is securely mounted onto the rotator (20) to prevent the positioning device (30) from detaching from the rotator (20). A through hole (41) is centrally defined in the holder (40) to allow the pipe (50) extending through the holder (40) and into an annular gap between the connecting section (13) and the bind ring (31).

With reference to FIGS. 3 and 4, when connecting the pipe to the pipe connector in accordance with the present invention, the pipe (50) longitudinally aligns with through hole (41) in the holder (40), and then extends through the holder (40) into the positioning device (30) and sleeved on the connecting section (13) of the hollow body (10). The pipe (50) slightly expands the series of engagements (332) when pass through the check washer (33). The pipe (50) is tightly bound to airtightly abut against the O-rings (131) due to the restitution force of the bind ring (31) when the pipe (50) pushes the opener (32) to make the opener (32) detaching from the protrusions (312) and abutting the first shoulder (121) such that the width of the slot (311) is shortened due to the restitution force of the bind ring (31). At the same time, the tapered plane (313) inwardly pushes the engagements (332) to make the engagements (332) securely engage to the outer periphery of the pipe when the inner diameter of the bind ring (31) is decreased. Consequently, the pipe (50) can not be detached form the connecting section (131) due to a fluid pressure therein after being connected.

In addition, the rotator (20), the positioning device (30) and the holder (40) are rotatable relative to the hollow body (10) such that the rotator (20), the positioning device (30) and the holder (40) are rotated with the pipe (50) to absorb the torsion from the pipe (50) when the pipe (50) is wrenched during operation. Consequently, the flowing speed and quantity of the fluid in the pipe (50) is smooth and stable.

For ensuring the assembling condition of the pipe (50), the rotator (20) is made of transparent material such that the operator can clearly observe that the pipe (50) pushes the opener (32) to the first shoulder (121) for ensuring the connection among the connecting section (13), the bind ring (31) and the pipe (50).

Although the invention has been explained in relation to its preferred embodiment, it is to be understood that many other possible modifications and variations can be made without departing from the spirit and scope of the invention as hereinafter claimed.

What is claimed is:

1. A pipe connector comprising:
a hollow body having a pivot section and a connecting section sequentially formed on one end thereof, wherein the pivot section has diameter greater than that of the connecting section such that a first shoulder is formed between the pivot section and the connecting section, at least one O-ring sleeved on the connecting section;
a rotator co-axially and rotatably mounted to the pivot section, the rotator having a second shoulder formed on an inner periphery thereof;
a positioning device co-axially mounted between the connecting section of the hollow body and the rotator, the positioning device including a bind ring surrounding the connecting section and having a slot defined in the bind ring such that bind ring has a C-shaped cross-section, the bind ring having multiple protrusions longitudinally extending from a first end thereof and each protrusion abutting against the first shoulder, a ring of inner tapered plane formed on a second end of the bind ring, an opener mounted among the multiple protrusions, wherein the opener has an outer diameter greater than that of an inner diameter of the bind ring such that the bind ring is expanded and the slot is widened when the opener mounted onto the first end of the bind ring, the opener having a diameter smaller than a width of the first shoulder, and a relative distance between the first shoulder and the second shoulder, a check washer mounted onto a distal end of the rotator opposite to the pivot section of the hollow body, the check having a ring structure and a series of engagements radially inwardly extending from the ring structure into the bind ring and abutting the tapered plane; and
a holder securely mounted onto the rotator to prevent the positioning device from detaching from the rotator, a through hole centrally defined in the holder to allow a pipe extending through the holder and into an annular gap between the connecting section and the bind ring.

2. The pipe connector as claimed in claim 1, wherein the rotator includes an annular groove defined in the distal end thereof for receiving the ring structure of the check washer, the annular groove communicating with the inner periphery of the rotator to allow the engagements extending into the bind ring.

3. The pipe connector as claimed in claim 1, wherein the rotator is made of transparent material such that the operator can clearly obverse the pipe during assembling the pipe.

4. The pipe connector as claimed in claim 2, wherein the rotator is made of transparent material such that the operator can clearly obverse the pipe during assembling the pipe.
